(19) United States
(12) Patent Application Publication
(10) Pub. No.: US 2025/0123251 A1
(43) Pub. Date: Apr. 17, 2025

(54) METHOD OF ANALYZING ISOPROPYLPHENYL PHOSPHATE

(71) Applicant: KABUSHIKI KAISHA TOSHIBA, Tokyo (JP)

(72) Inventors: Asato KONDO, Yokohama Kanagawa (JP); Mitsuhiro OKI, Kawasaki Kanagawa (JP); Takashi KUBOKI, Ota Tokyo (JP)

(73) Assignee: KABUSHIKI KAISHA TOSHIBA, Tokyo (JP)

(21) Appl. No.: 18/789,830

(22) Filed: Jul. 31, 2024

(30) Foreign Application Priority Data
Oct. 16, 2023 (JP) 2023-178077

(51) Int. Cl. G01N 30/86; G01N 30/02; G01N 30/06; G01N 30/72; G01N 30/88

(52) U.S. Cl. CPC G01N 30/8631; G01N 30/06; G01N 30/7206; G01N 30/88; G01N 2030/025; G01N 2030/884

(57) ABSTRACT

A method of analyzing isopropylphenyl phosphate according to an embodiment includes desorbing a sample by hot extraction, analyzing the desorbed sample to obtain a mass chromatogram of one or more compounds in the sample by gas chromatography mass spectrometry and determining whether the mass chromatogram includes one or more peaks of one or more product ions and/or one or more molecular ions each having a predetermined mass-to-charge ratio (m/z).

### CROSS-REFERENCE TO RELATED APPLICATION

This application is based upon and claims the benefit of priority from Japanese Patent Applications No. 2023-178077, the Filing Date of which is Oct. 16, 2023.

### FIELD

The present embodiments relate to a method of analyzing isopropylphenyl phosphate (Phenol, isopropylated, phosphate).

### BACKGROUND

Recently, restrictions on chemical substances have become stricter, and as a company that manufactures electrical and electronic equipment, etc., it is very important to control chemical substances in the constituent materials used in its products.

Aromatic phosphates, such as isopropylphenyl phosphate, are used as flame retardants, plasticizers for polyvinyl chloride, lubricating oil additives, and other products because of their flame resistance, hydrophobicity, plasticity, insulating properties, lubricity under high pressure to metals, and low cost.

Tris(isopropylphenyl) phosphate, referred to as PIP (3:1) which is isopropylphenyl phosphate, is a controlled substance under the U.S. Toxic Substances Control Act, and methods of analyzing propylphenyl phosphate are being studied.

### BRIEF DESCRIPTION OF THE DRAWINGS

FIG. 1 is a flowchart according to an embodiment.

FIG. 2 is a schematic diagram of an analysis apparatus according to an embodiment.

FIG. 3 shows chemical formulas of isopropylphenyl phosphate according to an embodiment.

FIG. 4 shows a chemical formula of triphenyl phosphate according to an embodiment.

FIG. 5 is a table of the preliminary experiment according to an embodiment.

FIG. 6 is a flowchart according to an embodiment.

FIG. 7 is a table of examples.

### DETAILED DESCRIPTION

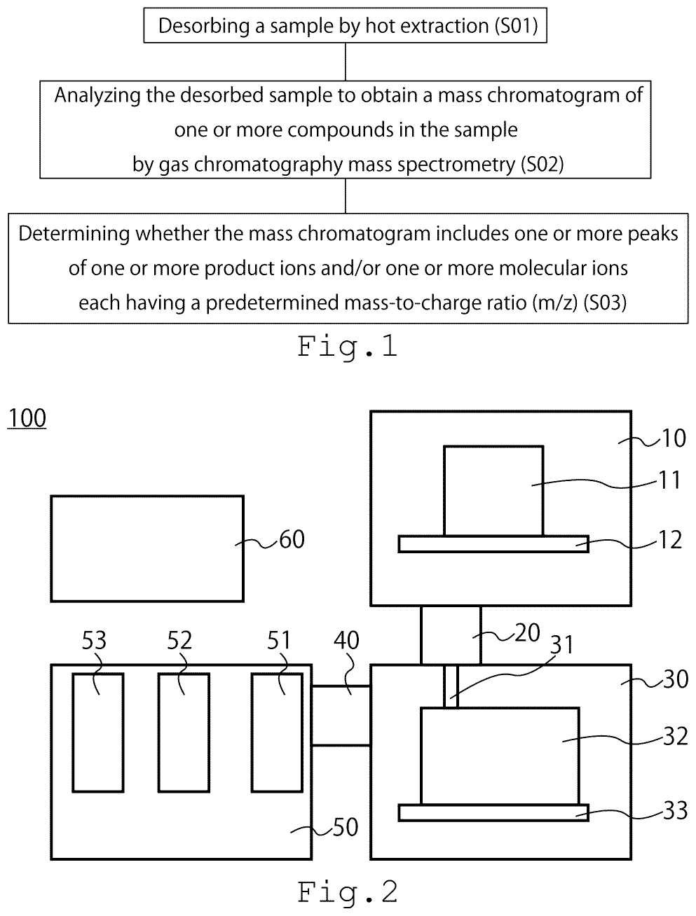

A method of analyzing isopropylphenyl phosphate according to an embodiment, as shown in the flowchart according to the embodiment in FIG. 1, includes desorbing a sample by hot extraction (S01), analyzing the desorbed sample to obtain a mass chromatogram of one or more compounds in the sample by gas chromatography mass spectrometry (S02), and determining whether the mass chromatogram includes one or more peaks of one or more product ions (one or more fragment ions) and/or one or more molecular ions (one or more precursor (parent) ions) each having a predetermined mass-to-charge ratio (m/z) (S03).

Hereinafter, a suitable embodiment will be described in detail with reference to the drawings. In the embodiment, unless otherwise specified, the conditions are those for a procedure conducted at 25° C. and atmospheric pressure (100 [kPa]). In the mathematical formula, “X” and “*” are the multiplication signs. In the mathematical formula, “/” is the division sign.

Compounds described in the specification include isomers.

### First Embodiment

A first embodiment relates to a method of analyzing isopropylphenyl phosphate. A method of analyzing isopropylphenyl phosphate of the first embodiment, as shown in the flowchart according to the embodiment in FIG. 1, includes desorbing a sample by hot extraction (S01), analyzing the desorbed sample to obtain a mass chromatogram of one or more compounds in the sample by gas chromatography mass spectrometry (S02), and determining whether the mass chromatogram includes (or does not include) one or more peaks of one or more product ions (one or more fragment ions) and/or one or more molecular ions (one or more parent ions) each having a predetermined mass-to-charge ratio (m/z) (S03).

A method of analyzing isopropylphenyl phosphate of the first embodiment in detail includes desorbing a sample by hot extraction (S01), analyzing the desorbed sample to obtain a mass chromatogram of one or more compounds in the sample by gas chromatography mass spectrometry (S02), and determining whether the mass chromatogram includes one or more peaks of one or more product ions each having a mass-to-charge ratio (m/z) of a value selected from the group consisting of 118, 145, 160, 251, 277, 293, 335, 353, 377, and 452 (S03).

A method of analyzing isopropylphenyl phosphate of the first embodiment in detail includes desorbing a sample by hot extraction at a temperature of 400 [° C.] or more and 700 [° C.] or less (S01), analyzing the desorbed sample to obtain a mass chromatogram of one or more compounds in the sample by gas chromatography mass spectrometry (S02), and determining whether the mass chromatogram includes a peak of a product ion having a mass-to-charge ratio (m/z) of 335 (S03).

A method of analyzing isopropylphenyl phosphate of the first embodiment in detail includes desorbing a sample by hot extraction (S01), analyzing the desorbed sample to obtain a mass chromatogram of one or more compounds in the sample by gas chromatography mass spectrometry (S02), and determining whether the mass chromatogram includes one or more peaks of one or more product ions each having a mass-to-charge ratio (m/z) of a value selected from the group consisting of 118, 251, and 335 (S03).

A method of analyzing isopropylphenyl phosphate of the first embodiment in detail includes desorbing a sample by hot extraction (S01), analyzing the desorbed sample to obtain a mass chromatogram of one or more compounds in the sample by gas chromatography mass spectrometry (S02), and determining whether the mass chromatogram includes one or more peaks of one or more product ions (first group) each having a mass-to-charge ratio (m/z) of a value selected from the group consisting of 118 and 251 and one or more peaks of one or more product ions (second group) each having a mass-to-charge ratio (m/z) of a value selected from the group consisting of 145 and 160 (S03).

A method of analyzing isopropylphenyl phosphate of the first embodiment in detail includes desorbing a sample by hot extraction (S01), analyzing the desorbed sample to obtain a mass chromatogram of one or more compounds in the sample by gas chromatography mass spectrometry (S02), and determining whether the mass chromatogram includes one or more peaks of one or more product ions each having a mass-to-charge ratio (m/z) of a value selected from the group consisting of 145 and 160 (S03).

A method of analyzing isopropylphenyl phosphate of the first embodiment in detail includes desorbing a sample by hot extraction (S01), analyzing the desorbed sample to obtain a mass chromatogram of one or more compounds in the sample by gas chromatography mass spectrometry (S02), and determining whether the mass chromatogram includes peaks of two or more product ions each having a mass-to-charge ratio (m/z) of a value selected from the group consisting of 118, 145, 160, 251, and 335 (S03).

A schematic conceptual diagram of an analysis apparatus used for the analysis according to the first embodiment is shown in FIG. 2. The analysis apparatus 100 of FIG. 2 includes a pyrolizer 10, a first interface 20 a gas chromatograph 30, a second interface 40, a mass spectrometer 50, and a control unit 60. The schematic conceptual diagram of the analysis apparatus 100 of FIG. 2 is one conceptual example for Pyrolysis-Gas Chromatograph/Mass spectrometer (Py-GC/MS).

The pyrolizer 10 have a heating furnace 11 that heats a sample. The sample is desorbed by the hot extraction in the pyrolizer 10, and gas is generated. The heating furnace 11 has a heater 12 and temperature inside the heating furnace 11 is conditioned. It is preferable that carrier gas is introduced into the heating furnace 11. The carrier gas is, for example, helium and/or nitrogen. The desorption of the sample by the hot extraction (S01) is carried out in the pyrolizer 10.

The gas generated by desorbing the sample in the pyrolizer 10 is introduced through the first interface 20 to the gas chromatograph 30.

The gas chromatograph 30 has an injection port 31, a capillary column 32, a capillary heater 33. The generated gas is separated by the gas chromatograph 30. The generated gas is injected into the injection port 31 and is introduced into the capillary column 32. The capillary heater 33 can control temperature of the capillary column 32.

The separated gas is introduced through the second interface 40 to the mass spectrometer 50.

The mass spectrometer 50 has an ion source (ionization unit) 51, a mass analyzer (mass filter) 52, and a detector 53. Compounds included in the separated gas is ionized by the ion source 51. The ionized compound is separated depending on a mass-to-charge ratio (m/z) and a mass chromatogram is created for each compound with the detector. A total ion chromatogram (TIC) is created by adding all peaks of mass-to-charge ratios of the obtained (created) mass chromatogram. The analyzing the desorbed sample to obtain a mass chromatogram of one or more compounds in the sample by gas chromatography mass spectrometry (S02) is carried out in the spectrometer 50.

The control unit 60 connects to the pyrolizer 10, the gas chromatograph 30, the mass spectrometer, and the other(s) with wires which are not shown in drawings and controls these connected devices. The control unit 60 controls process conditions for the analyzing method of the first embodiment. The control unit 60 is, for example, a computer. The determining whether the mass chromatogram includes one or more peaks of one or more product ions and/or one or more molecular ions each having a predetermined mass-to-charge ratio (m/z) (S03) is carried out by the control unit 60.

It is preferable that the sample is a substance including resin or lubricant. Isopropylphenyl phosphate in the sample is desorbed from the sample by the hot extraction with the pyrolizer 10. The sample is decomposed (desorbed) in the desorbing a sample by the hot extraction (S01) and used for the analysis. When the sample is heated, gas including compounds to be analyzed is generated. In the embodiment, it is determined whether the sample includes isopropylphenyl phosphate by qualitative analyzing of the compound in the generated gas.

The method of analyzing embodiments can analyze isopropylphenyl phosphate including also other than tris(isopropylphenyl) phosphate.

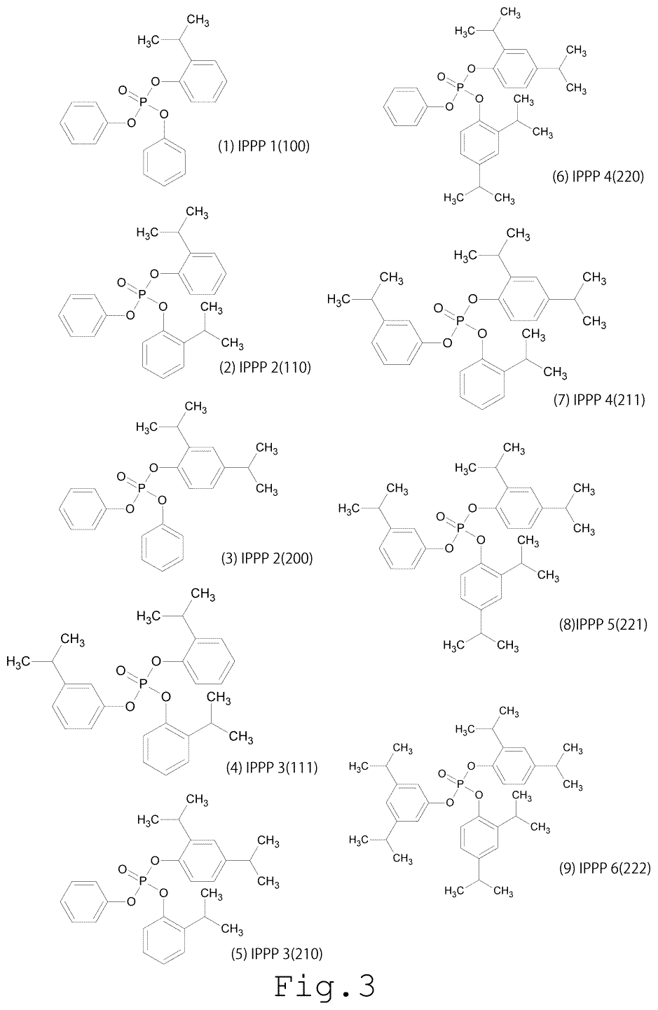

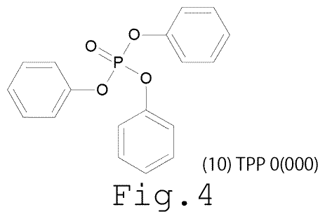

Chemical formulas of isopropylphenyl phosphate are shown in FIG. 3. A chemical formula of triphenyl phosphate shown is in FIG. 4. Isopropylphenyl phosphate has three phenyl groups (first phenyl group (a phenyl group on the upper right side of a chemical formula), second phenyl group (a phenyl group on the lower middle side of a chemical formula), and third phenyl group (a phenyl group on the left side of a chemical formula)) and the phenyl groups includes a total of 1 or more and 6 or less of isopropyl groups. Each phenyl group includes 0 or more and 2 or less of isopropyl groups. Although isomers are distinguished by gas chromatography, the chemical formulas in FIG. 3 and the like do not distinguish isomers.

Numbers of IPPP 3(111) and the like shown in FIG. 3 and FIG. 4 are, from left to right, a total number of the isopropyl group (a number outside the parentheses), a number of the isopropyl group included in the first phenyl group (a number on the left side in the parentheses), a number of the isopropyl group included in the second phenyl group (a number at the center of the parentheses), and a number of the isopropyl group included in the third phenyl group (a number on the right side in the parentheses).

The isopropylphenyl phosphate shown as a chemical formula (1) in FIG. 3 is represented as IPPP 1(100) in the drawing. The isopropylphenyl phosphate shown as the chemical formula (1) includes one isopropyl group in the first phenyl group, the second phenyl group is unsubstituted, and the third phenyl group is unsubstituted.

The isopropylphenyl phosphate shown as a chemical formula (2) in FIG. 3 is represented as IPPP 2(110) in the drawing. The isopropylphenyl phosphate shown as the chemical formula (2) includes one isopropyl group in the first phenyl group and one isopropyl group in the second phenyl group and the third phenyl group is unsubstituted.

The isopropylphenyl phosphate shown as a chemical formula (3) in FIG. 3 is represented as IPPP 2(200) in the drawing. The isopropylphenyl phosphate shown as the chemical formula (3) includes two isopropyl groups in the first phenyl group, the second phenyl group is unsubstituted, and the third phenyl group is unsubstituted.

The isopropylphenyl phosphate shown as a chemical formula (4) in FIG. 3 is represented as IPPP 3(111) in the drawing. The isopropylphenyl phosphate shown as the chemical formula (4) includes one isopropyl group in the first phenyl group, one isopropyl group in the second phenyl group, and one isopropyl group in the third phenyl group. The isopropylphenyl phosphate shown as the chemical formula (4) in the FIG. 3 is tris(isopropylphenyl) phosphate.

The isopropylphenyl phosphate shown as a chemical formula (5) in FIG. 3 is represented as IPPP 3(210) in the drawing. The isopropylphenyl phosphate shown as the chemical formula (5) includes two isopropyl groups in the first phenyl group and one isopropyl group in the second phenyl group and the third phenyl group is unsubstituted.

The isopropylphenyl phosphate shown as a chemical formula (6) in FIG. 3 is represented as IPPP 4(220) in the drawing. The isopropylphenyl phosphate shown as the chemical formula (6) includes two isopropyl groups in the first phenyl group and two isopropyl groups in the second phenyl group and the third phenyl group is unsubstituted.

The isopropylphenyl phosphate shown as a chemical formula (7) in FIG. 3 is represented as IPPP 4(211) in the drawing. The isopropylphenyl phosphate shown as the chemical formula (7) includes two isopropyl groups in the first phenyl group, one isopropyl group in the second phenyl group, and one isopropyl group in the third phenyl group.

The isopropylphenyl phosphate shown as a chemical formula (8) in FIG. 3 is represented as IPPP 5(221) in the drawing. The isopropylphenyl phosphate shown as the chemical formula (8) includes two isopropyl groups in the first phenyl group, two isopropyl groups in the second phenyl group, and one isopropyl group in the third phenyl group.

The isopropylphenyl phosphate shown as a chemical formula (9) in FIG. 3 is represented as IPPP 6(222) in the drawing. The isopropylphenyl phosphate shown as the chemical formula (9) includes two isopropyl groups in the first phenyl group, two isopropyl groups in the second phenyl group, and two isopropyl groups in the third phenyl group.

The isopropylphenyl phosphate shown as a chemical formula (10) in FIG. 4 is represented as IPPP 0(000) in the drawing. The isopropylphenyl phosphate shown as the chemical formula (10) includes three phenyl groups (the first phenyl group, the second phenyl group, and the third phenyl group) and all phenyl groups are unsubstituted.

During desorbing the sample by the hot extraction (S01), temperature (temperature inside the heating furnace 11) of desorption of the sample by the hot extraction is preferably 400 [° C.] or more and 700 [° C.] or less. If the temperature of desorption of the sample is 300 [° C.] which is typical temperature of the hot extraction for analyzing isopropylphenyl phosphate, the temperature is high enough for analyzing tris(isopropylphenyl) phosphate which is included in GC/MS library, however when isopropylphenyl phosphate that is not tris(isopropylphenyl) phosphate which is not included GC/MS library is analyzed, analysis of some of isopropylphenyl phosphate whose molecular weight is large is difficult since the temperature of desorption of the sample is not high enough. When the temperature of desorption of the sample exceeds 700 [° C.], isopropylphenyl phosphate is easy to be decomposed. Therefore, the temperature of desorption of the sample is preferably 400 [° C.] or more 700 [° C.] or less, and more preferably 450 [° C.] or more and 650 [° C.] or less.

During the desorbing the sample by the hot extraction (S01), temperature of the first interface 20 in which the generated gas passes is, typically, but not limited to 300 [° C.].

The generated gas is separated for each component during the analyzing the desorbed sample to obtain a mass chromatogram of one or more compounds in the sample by gas chromatography mass spectrometry (S02). The generated gas which has passed through the first interface 20 is separated in the capillary column 32 of the gas chromatograph 30.

Temperature of the injection port 31 is, typically, but not limited to 300 [° C.].

It is preferable that the capillary column 32 with, for example, dimethyl polysiloxane or diphenyl dimethylpolysiloxane as a stationary phase.

When the inner diameter of the capillary column 32 is, for example, 0.25 [mm], a split ratio is preferably 50:1 to 100:1.

For temperature conditioning of the capillary column 32, it is preferable to apply increasing temperature. For example, after flowing a carrier gas such as He or the like at room temperature (25 [° C.]), the generated gas at, for example, 40 [° C.] is injected, and after 2 minutes, the temperature of the capillary column is increased at 10 [° C./min] to 300 [° C.] or more and 350 [° C.] or less.

The separated gas for each component is ionized by electron impact (EI). Molecular ions, from which compound in each component is ionized and product ions, which is produced by decomposing (fragmentation) of compound in each component during ionization, are separated by a mass-to-charge ratio in the mass analyzer 52. The separated ions are detected in the detector 53 and a mass chromatogram of the compound is obtained. The mass range m/z of the detector 53 is preferably 10 or more and 600 or less.

The obtained mass chromatogram is used to determine whether isopropylphenyl phosphate is included in the sample. The determination may be made automatically by the control unit 60 or by an analyst.

Next, a preliminary experiment is described to explain the determination whether isopropylphenyl phosphate is included in the sample. The conditions of the preliminary experiment are described below.

### Conditions 1

Temperature of pyrolizer for desorption by hot extraction: 600 [° C.].
Temperature of interface of pyrolizer: automatic.
Column of gas chromatograph: 5% diphenyl dimethyl polysiloxane, length 30 [m], internal diameter 0.25 [mm], film thickness 0.05 [μm].
Injection temperature of gas chromatograph: 300 [° C.].
Column oven temperature of gas chromatograph: 40 [° C.] (2 minutes retention), increase at 10 [° C./min], up to 320 [° C.].
Injection mode of gas chromatograph: Split 1/50.
Carrier gas of gas chromatograph: He 1 [mL/min], constant flow.
Ionizing method of mass analyzer: EI (Electron Ionization) 70 [eV].
Ion source temperature of mass analyzer: 230 [° C.].
Scan range of mass analyzer: m/z 10 to 600.

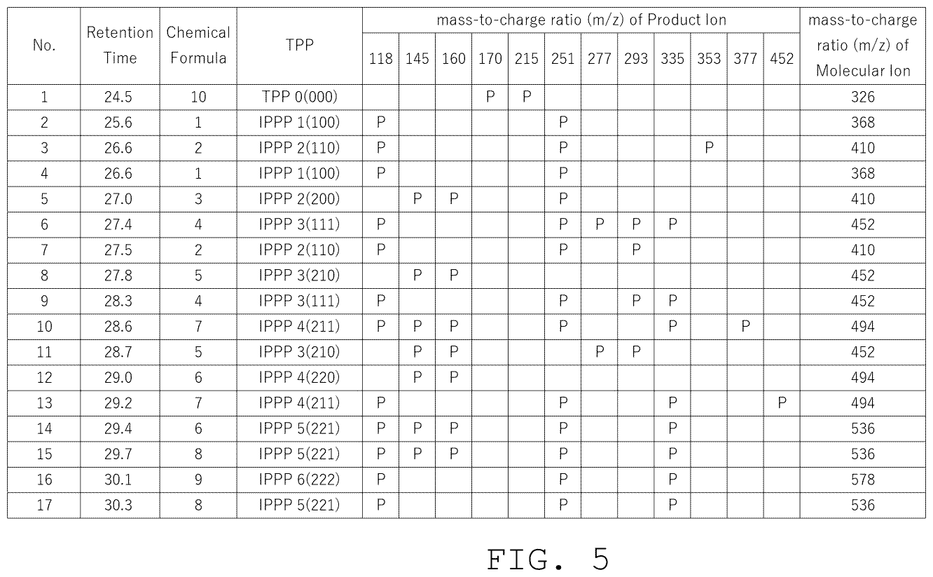

A sample including various isopropylphenyl phosphates is analyzed by the above method under the above conditions, the results shown in a table of the preliminary experiment in FIG. 5 are obtained. In the tables shown in FIG. 5, retention time, compounds, product ions, and molecular ions are shown. The results shown in the table of FIG. 5 also include information related to mass-to-charge ratios (m/z) of isopropylphenyl phosphate which is not listed in the GC/MS library. The table of FIG. 5 shows, for example, the chromatograph of the compound having the retention time of No. 1 includes a peak of a product ion having a mass-to-charge ratio of 170 and a peak of a product ion having a mass-to-charge ratio of 215 and does not include peaks of product ions each having a mass-to-charge ratio of a value selected from the group consisting of 118, 145, 160, 251, 277, 293, 335, 353, 377, and 452.

From this result, a determination can be made for isopropylphenyl phosphates besides tris(isopropylphenyl) phosphate, considering the number of phenyl groups to which isopropyl group(s) has been introduced.

When the GC/MS library is used for the determination as a standard, the determination cannot be made for compounds that are not listed in the GC/MS library, but the method of the embodiment can determine the compounds under the analytical conditions freely selected by the analyst, without relying on the GC/MS library.

Focusing only on the molecular ion may lead to the determination that a sample which contains a compound of the same molecular weight but does not include isopropylphenyl phosphate is determined to include isopropylphenyl phosphate.

In determining whether a sample contains a substance subject to regulation (2021) under Article 6(h) of the Toxic Substances Control Act (TSCA) (“isopropylphenyl phosphate”, a so-called PIP (3:1), in which one or more isopropyl groups are introduced into all three phenyl groups), it is not possible to determine whether the sample contains PIP (3:1) by focusing on the molecular ion when the sample includes isopropylphenyl phosphate with a total of up to four isopropyl groups.

Therefore, reliable analysis can be performed by first conducting the determination based on the product ion and then conducting a supplemental determination based on the molecular ion.

In the determining whether the mass chromatogram includes one or more peaks of one or more product ions and/or one or more molecular ions each having a predetermined mass-to-charge ratio (m/z) (S03), whether the sample includes isopropylphenyl phosphate by following method A to method F is evaluated. Furthermore, it is preferable that whether the mass chromatogram includes one or more peaks each having a mass-to-charge (m/z) related to one or more molecular ions of isopropylphenyl phosphate is evaluated.

### Method A

In the determining whether the mass chromatogram includes one or more peaks of one or more product ions and/or one or more molecular ions having a predetermined mass-to-charge ratio (m/z) (S03), whether the mass chromatogram includes one or more peaks of one or more product ions each having a mass-to-charge ratio (m/z) of a value selected from the group consisting of 118, 145, 160, 251, 277, 293, 335, 353, 377, and 452 is evaluated.

A mass chromatogram of the isopropylphenyl phosphates shown in chemical formulas of FIG. 3 includes one or more peaks of one or more product ions each having a mas-by-charge ratio (m/z) of a value selected from the group consisting of 118, 145, 160, 251, 277, 293, 335, 353, 377, and 452.

Determination by the method A can be used to determine whether the sample contains isopropylphenyl phosphate, in which one or more isopropyl groups are introduced into one or more of the phenyl groups. For the determination of the method A, the total ion chromatogram is not used. The method A is useful as an easy screening method since the determination of the method A is available without evaluating between each obtained mass chromatogram and a mass chromatogram of isopropylphenyl phosphate listed in a GC/MS library.

The desorbing temperature by the hot extraction for the method A is preferably 400 [° C.] or more and 700 [° C.] or less, or 450 [° C.] or more and 650 [° C.] or less, which contributes to the improvement for the reliability of the analysis.

When the method A is used for the determination, it is preferable that isopropylphenyl phosphate is determined to be present in the sample from mass chromatograms which are obtained from two or more compounds. When the method A is used for the determination, it is preferable that two or more compounds of isopropylphenyl phosphate in which isomers are regarded as different compounds are determined to be present in the sample. Additionally, when the method A is used for the determination, it is preferable that isomers of isopropylphenyl phosphate are determined to be present. The determination with several compounds by these methods improves the reliability of the analysis.

When the method A is used for the determination, when the mass chromatogram that includes one or more peaks of one or more product ions each having a mass-by-charge ratio of a value selected from the group consisting of 118, 145, 160, 251, 277, 293, 335, 353, 377, and 452 includes one or more peaks of one or more molecular ions each having a mass-by-charge ratio of a value selected from the group consisting of 368, 410, 452, 494, 536, and 578 is also evaluated, which contributes to the improvement for the reliability of the analysis.

When a mass chromatogram includes a peak of a product ion having a mass-to-charge ratio (m/z) of 118 and includes a peak of a molecular ion having a mass-to-charge ratio (m/z) of 368, 410, 452, 494, 536, or 578, isopropylphenyl phosphate can be determined to be present in the sample.

When a mass chromatogram includes a peak of a product ion having a mass-to-charge ratio (m/z) of 145 and includes a peak of a molecular ion having a mass-to-charge (m/z) of 410, ratio 452, 494, or 536, isopropylphenyl phosphate can be determined to be present in the sample.

When a mass chromatogram includes a peak of a product ion having a mass-to-charge ratio of 160 and includes a peak of a molecular ion having a mass-to-charge ratio of 410, 452, 494, or 536, isopropylphenyl phosphate can be determined to be present in the sample.

When a mass chromatogram includes a peak of a product ion having a mass-to-charge ratio of 251 and includes a peak of a molecular ion having a mass-to-charge ratio of 368, 410, 452, 494, 536, or 578, isopropylphenyl phosphate can be determined to be present in the sample.

When a mass chromatogram includes a peak of a product ion having a mass-to-charge ratio of 277 and includes a peak of a molecular ion having the mass-to-charge ratio of 452, isopropylphenyl phosphate can be determined to be present in the sample.

When a mass chromatogram includes a peak of a product ion having a mass-to-charge ratio of 293 and includes a peak of a molecular ion having a mass-to-charge ratio of 452, isopropylphenyl phosphate can be determined to be present in the sample.

When a mass chromatogram includes a peak of a product ion having a mass-to-charge ratio of 335 and includes a peak of a molecular ion each having a mass-to-charge ratio of 410, 452, 494, 536, or 578, isopropylphenyl phosphate can be determined to be present in the sample.

When a mass chromatogram includes a peak of a product ion having a mass-to-charge ratio of 353 and includes a peak of a molecular ion having a mass-to-charge ratio of 410, isopropylphenyl phosphate can be determined to be present in the sample.

When a mass chromatogram includes a peak of a product ion having a mass-to-charge ratio of 377, isopropylphenyl phosphate can be determined to be present or absent in the sample by observing a peak of a molecular ion having a mass-to-charge ratio of 494 in the mass chromatogram which includes the peak of the product ion having the mass-to-charge ratio of 377.

When a mass chromatogram includes a peak of a product ion having a mass-to-charge ratio of 452 and includes a peak of a molecular ion having a mass-to-charge ratio of 536, isopropylphenyl phosphate can be determined to be present in the sample.

### Method B

In the determining whether the mass chromatogram includes one or more peaks of one or more product ions and/or one or more molecular ions each having a predetermined mass-to-charge ratio (m/z) (S03), whether the mass chromatogram includes or does not include a peak of a product ion having a mass-to-charge ratio (m/z) of 335 is evaluated.

Determination by the method B can be used to determine whether the sample includes or does not include isopropylphenyl phosphate, in which one or more isopropyl groups are introduced into all the three phenyl groups. It can be determined whether the sample includes or does not include the substance subject to regulation (2021) under Article 6(h) of the Toxic Substances Control Act (TSCA) (“isopropylphenyl phosphate”, a so-called PIP (3:1), in which one or more isopropyl groups are introduced into all the three phenyl groups) by using the method B.

By using the method B, it can be determined whether the sample includes or does not include isopropylphenyl phosphate, in which one or more isopropyl groups are introduced into all the three phenyl groups without focusing on the mass-to-charge ratio of many product ions.

By using the method B, it can be correctly determined even when the sample includes isopropylphenyl phosphate, in which one or more isopropyl groups are introduced into all the three phenyl groups besides tris(isopropylphenyl) phosphate included in a GC/MS library.

Regarding to the determination of the method B, a total ion chromatogram is not used. The determination of the method B can be carried out without evaluating similarity between each obtained mass chromatogram and a mass chromatogram of isopropylphenyl phosphate included in a GC/MS library, the method B is useful as an easy screening method.

The desorbing temperature by the hot extraction for the method B is preferably 400 [° C.] or more and 700 [° C.] or less, or 450 [° C.] or more and 650 [° C.] or less, which contributes to the improvement for the reliability of the analysis.

When the method B is used for the determination, it is preferable that whether the mass chromatogram which includes the peak of the product ion having a mass-to-charge ratio (m/z) of 335 includes or does not include one or more peaks of one or more molecular ions each having a mass-to-charge ratio of a value selected from the group consisting of 452, 494, 536, and 578 is further evaluated, which contributes to the improvement for the reliability of the analysis.

When the method B is used for the determination, it is preferable that isopropylphenyl phosphate is determined to be present in the sample from mass chromatograms which are obtained from two or more compounds. When the method B is used for the determination, it is preferable that two or more compound of isopropylphenyl phosphate in which isomers are regarded as different compounds are determined to be present in the sample. Additionally, when the method B is used for the determination, it is preferable that isomers of isopropylphenyl phosphate are determined to be present. The determination with several compounds by these methods improves the reliability of the analysis.

### Method C

In the determining whether the mass chromatogram includes one or more peaks of one or more product ions and/or one or more molecular ions each having a predetermined mass-to-charge ratio (m/z) (S03), whether the mass chromatogram includes one or more peaks of one or more product ions each having a mass-to-charge ratio (m/z) of selected from the group consisting of 118, 251, and 335 is evaluated.

In the determination of the method C, it is preferable that whether the mass chromatogram includes two or more peaks of two or more product ions each having a mass-to-charge ratio (m/z) of selected from the group consisting of 118, 251, and 335 is evaluated. In the determination of the method C, it is more preferable that whether the mass chromatogram includes peaks of all the product ions each having a mass-to-charge ratio (m/z) of selected from the group consisting of 118, 251, and 335 is evaluated.

In the determination of the method C, when the mass chromatogram includes two or more peaks of two or more product ions each having a mass-to-charge ratio (m/z) of selected from the group consisting of 118, 251, and 335 is evaluated, which contributes to the improvement for the reliability of the analysis. For example, mass chromatograms of a compound whose retention time is 27.4 [min] and a compound whose retention time is 29.2 [min] as shown in the table of FIG. 5 include peaks of all the product ions each having the mass-to-charge ratio of selected from the group consisting of 118, 251, and 335.

In the determination of the method C, the total ion chromatogram is not used. In the determination of the method C, whether isopropylphenyl phosphate is included in the sample can be evaluated regardless of absence or presence of tris(propylphenyl phosphate which is a representative of isopropylphenyl phosphate. The determination of the method C can be carried out without evaluating similarity between each obtained mass chromatogram and a mass chromatogram of isopropylphenyl phosphate included in a GC/MS library, the method C is useful as an easy screening method.

The desorbing temperature by the hot extraction for the method C is preferably 400 [° C.] or more and 700 [° C.] or less, or 450 [° C.] or more and 650 [° C.] or less, which contributes to the improvement for the reliability of the analysis.

When the method C is used for the determination, the mass chromatogram which includes one or more peaks of one or more product ions each having a mass-to-charge ratio (m/z) of a value selected from the group consisting of 118, 251, and 335 includes one or more peaks of one or more molecular ions each having a mass-to-charge ratio (m/z) of a value selected from the group consisting of 368, 410, 452, 494, 536, and 578 is also evaluated preferably, which contributes to the improvement for the reliability of the analysis.

When the method C is used for the determination, it is preferable that isopropylphenyl phosphate is determined to be present in the sample from mass chromatograms which are obtained from two or more compounds. When the method C is used for the determination, it is preferable that two or more compound of isopropylphenyl phosphate in which isomers are regarded as different compounds are determined to be present in the sample. Additionally, when the method C is used for the determination, it is preferable that isomers of isopropylphenyl phosphate are determined to be present. The determination with several compounds by these methods improves the reliability of the analysis.

### Method D

In the determining whether the mass chromatogram includes one or more peaks of one or more product ions and/or one or more molecular ions each having a predetermined mass-to-charge ratio (m/z) (S03), whether the mass chromatogram includes or does not include one or more peaks of one or more product ions (first group) each having a mass-to-charge ratio (m/z) of selected from the group consisting of 118 and 251, and one or more peaks of one or more product ions (second group) each having a mass-to-charge ratio (m/z) of selected from the group consisting of 145 and 160 is evaluated.

The compounds whose mass chromatogram includes a peak of a product ion having a mass-to-charge ratio of 118 is mostly common to the compounds whose mass chromatogram includes a peak of a product ion having a mass-to-charge ratio of 251. The compounds whose mass chromatogram includes a peak of a product ion having a mass-to-charge ratio of 145 is common to the compounds whose mass chromatogram includes a peak of a product ion having a mass-to-charge ratio of 160. Therefore, when the first group or/and the second group is included, it is determined that isopropylphenyl phosphate is included in the sample.

In the determining whether the mass chromatogram includes one or more peaks of one or more product ions and/or one or more molecular ions each having a predetermined mass-to-charge ratio (m/z) (S03), it is preferable that whether the mass chromatogram includes or does not include one or more peaks of one or more product ions (first group) each having a mass-to-charge ratio (m/z) of selected from the group consisting of 118 and 251, and one or more peaks of one or more product ions (second group) each having a mass-to-charge ratio (m/z) of selected from the group consisting of 145 and 160 is evaluated.

By using the method D, whether the sample include or does not include isopropylphenyl phosphate can be evaluated, even when the kind of the target product ion is few. In the determination of the method D, the total ion chromatogram is not used. The determination of the method D can be carried out without evaluating similarity between each obtained mass chromatogram and a mass chromatogram of isopropylphenyl phosphate included in a GC/MS library, the method D is useful as an easy screening method.

The desorbing temperature by the hot extraction for the method D is preferably 400 [° C.] or more and 700 [° C.] or less, or 450 [° C.] or more and 650 [° C.] or less, which contributes to the improvement for the reliability of the analysis.

When the method D is used for the determination, whether the mass chromatogram which includes one or more peaks of one or more product ions (first group) each having a mass-to-charge ratio (m/z) of selected from the group consisting of 118 and 251, and also one or more peaks of one or more product ions (second group) each having a mass-to-charge ratio (m/z) of selected from the group consisting of 145 and 160, includes or does not include one or more peaks of one or more molecular ions each having a mass-to-charge ratio (m/z) of a value selected from the group consisting of 368, 410, 452, 494, 536, and 578 is also evaluated preferably, which contributes to the improvement for the reliability of the analysis.

When the method D is used for the determination, it is preferable that isopropylphenyl phosphate is determined to be present in the sample from mass chromatograms which are obtained from two or more compounds. When the method D is used for the determination, it is preferable that two or more compound of isopropylphenyl phosphate in which isomers are regarded as different compounds are determined to be present in the sample. Additionally, when the method D is used for the determination, it is preferable that isomers of isopropylphenyl phosphate are determined to be present. The determination with several compounds by these methods improves the reliability of the analysis.

### Method E

In the determining whether the mass chromatogram includes one or more peaks of one or more product ions and/or one or more molecular ions each having a predetermined mass-to-charge ratio (m/z) (S03), whether the mass chromatogram includes or does not include one or more peaks of one or more product ions each having a mass-to-charge ratio (m/z) of selected from the group consisting of 145 and 160 is evaluated.

In the determination of the method E, it is preferable that whether the mass chromatogram includes or does not include both the peak of the product ion each having a mass-to-charge ratio (m/z) of 145 and the peak of the product ion each having a mass-to-charge ratio (m/z) of 160 is evaluated.

In the determination of the method E, the total ion chromatogram is not used. In the determination of the method E whether isopropylphenyl phosphate is included in the sample can be evaluated regardless of absence or presence of tris(propylphenyl phosphate which is a representative of isopropylphenyl phosphate. The determination of the method E can be carried out without evaluating similarity between each obtained mass chromatogram and a mass chromatogram of isopropylphenyl phosphate included in a GC/MS library, the method E is useful as an easy screening method.

The desorbing temperature by the hot extraction for the method E is preferably 400 [° C.] or more and 700 [° C.] or less, or 450 [° C.] or more and 650 [° C.] or less, which contributes to the improvement for the reliability of the analysis.

When the method E is used for the determination, whether the mass chromatogram which includes one or more peaks of one or more product ions each having a mass-to-charge ratio (m/z) of selected from the group consisting of 145 and 160 includes or does not include one or more peaks of one or more molecular ions each having a mass-to-charge ratio (m/z) of a value selected from the group consisting of 410, 452, 494, and 536 is also evaluated preferably, which contributes to the improvement for the reliability of the analysis.

When the method E is used for the determination, it is preferable that isopropylphenyl phosphate is determined to be present in the sample from mass chromatograms which are obtained from two or more compounds. When the method E is used for the determination, it is preferable that two or more compound of isopropylphenyl phosphate in which isomers are regarded as different compounds are determined to be present in the sample. Additionally, when the method E is used for the determination, it is preferable that isomers of isopropylphenyl phosphate are determined to be present. The determination with several compounds by these methods improves the reliability of the analysis.

### Method F

In the determining whether the mass chromatogram includes one or more peaks of one or more product ions and/or one or more molecular ions each having a predetermined mass-to-charge ratio (m/z) (S03), whether the mass chromatogram includes or does not include two or more peaks of two or more product ions each having a mass-to-charge ratio (m/z) of selected from the group consisting of 118, 145, 160, 251, and 335 is evaluated.

In the determination of the method F, the total ion chromatogram is not used. In the determination of the method F whether isopropylphenyl phosphate is included in the sample can be evaluated regardless of absence or presence of tris(propylphenyl phosphate which is a representative of isopropylphenyl phosphate. The determination of the method E can be carried out without evaluating similarity between each obtained mass chromatogram and a mass chromatogram of isopropylphenyl phosphate included in a GC/MS library, the method F is useful as an easy screening method.

The desorbing temperature by the hot extraction for the method F is preferably 400 [° C.] or more and 700 [° C.] or less, or 450 [° C.] or more and 650 [° C.] or less, which contributes to the improvement for the reliability of the analysis.

When the method F is used for the determination, whether the mass chromatogram includes two or more peaks of two or more product ions each having a mass-to-charge ratio (m/z) of selected from the group consisting of 118, 145, 160, 251, and 335 includes or does not include one or more peaks of one or more molecular ions each having a mass-to-charge ratio (m/z) of a value selected from the group consisting of 368, 410, 452, 494, 536, and 578 is also evaluated preferably, which contributes to the improvement for the reliability of the analysis.

When the method F is used for the determination, it is preferable that isopropylphenyl phosphate is determined to be present in the sample from the mass chromatograms which are obtained from two or more compounds. When the method F is used for the determination, it is preferable that two or more compound of isopropylphenyl phosphate in which isomers are regarded as different compounds are determined to be present in the sample. the method F is used for the determination, it is Additionally, when preferable that isomers of isopropylphenyl phosphate are determined to be present. The determination with several compounds by these methods improves the reliability of the analysis.

### Second Embodiment

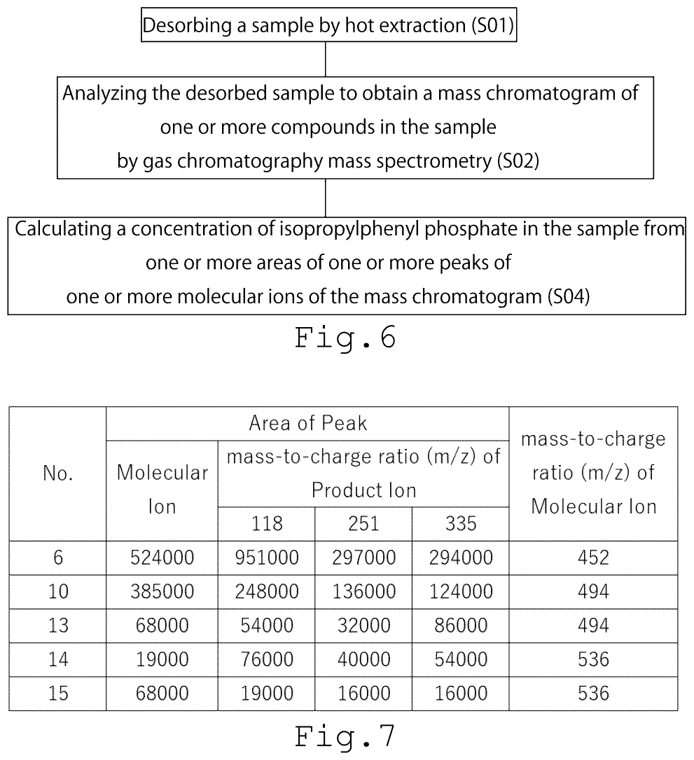

A second embodiment relates to a method of analyzing isopropylphenyl phosphate. The method of analyzing isopropylphenyl phosphate of the second embodiment, as shown in the flowchart according to the embodiment in FIG. 6, includes desorbing a sample by hot extraction (S01), analyzing the desorbed sample to obtain a mass chromatogram of one or more compounds in the sample by gas chromatography mass spectrometry (S02), and calculating a concentration of isopropylphenyl phosphate in the sample from one or more areas of one or more peaks of one or more molecular ions of the mass chromatogram (S04).

The analyzing method of the second embodiment is partially common to the analyzing method of the first embodiment. The description will be omitted for the contents common to the first embodiment and the second embodiment.

Regarding to the desorbing a sample by the hot extraction (S01) and the analyzing the desorbed sample to obtain a mass chromatogram of one or more compounds in the sample by gas chromatography mass spectrometry, the analyzing method of the second embodiment is common to the analyzing method of the first embodiment.

An analysis apparatus used for the second embodiment can be common to the analysis apparatus 100 used for the first embodiment.

The analyzing method of the second embodiment is different from the analyzing method of the first embodiment in that the analyzing method of the second embodiment includes the calculating a concentration of isopropylphenyl phosphate in the sample from one or more areas of one or more peaks of one or more molecular ions of the mass chromatogram (S04). Regarding to the analyzing method of the second embodiment, the analyzing method of the second embodiment may include the determining whether the mass chromatogram includes one or more peaks of one or more product ions and/or one or more molecular ions each having a predetermined mass-to-charge ratio (m/z) (S03).

In the calculating a concentration of isopropylphenyl phosphate in the sample from one or more areas of one or more peaks of one or more molecular ions of the mass chromatogram (S04), the concentration of isopropylphenyl phosphate is calculated from the one or more areas of the molecular ions of the mass chromatogram, but not of the total ion chromatogram. The total ion chromatogram includes all peaks of molecular ions and all peaks of product ions. In gas chromatography, quantitative evaluation is usually performed using the total ion chromatogram as the basis, but it was found that the determination of isopropylphenyl phosphate using the total ion chromatogram as the basis may have a large error margin.

Therefore, regarding the analyzing method of the embodiment, the quantitation of isopropylphenyl phosphate is performed from the one or more areas of the one or more molecular ions rather than the total ion chromatogram. The quantitation of isopropylphenyl phosphate is preferably performed from the one or more areas of the one or more molecular ions excluding one or more areas of one or more product ions.

In the calculating a concentration of isopropylphenyl phosphate in the sample from one or more areas of one or more peaks of one or more molecular ions of the mass chromatogram (S04), specifically, the concentration of isopropylphenyl phosphate is calculated from a ratio “a total peak area of one or more molecular ions of isopropylphenyl phosphate of the mass chromatogram obtained by analyzing the sample” to “a peak area of a molecular ion of tris(isopropylphenyl) phosphate of a mass chromatogram obtained by analyzing a standard sample which includes tris(isopropylphenyl) phosphate by pyrolysis gas chromatography mass spectrometry”.

The concentration of isopropylphenyl phosphate in the sample is obtained, for example, from the following equation.

[Concentration of isopropylphenyl phosphate in the sample]=[Total peak area of one or more molecular ions of isopropylphenyl phosphate of the mass chromatogram obtained by analyzing the sample]/[Peak area of a molecular ion of tris(isopropylphenyl) phosphate of a mass chromatogram obtained by analyzing a standard sample]*[Weight of the sample for the analysis]/[Weight of the standard sample for the analysis]* [Concentration of tris(isopropylphenyl) phosphate of the standard sample]

The concentration of isopropylphenyl phosphate in the sample is obtained by using an equation of a calibration curve prepared from the peak area of the molecular ion of tris(isopropylphenyl) phosphate in the mass chromatogram of the standard sample.

Preferable conditions of the second embodiment for the pyrolysis gas chromatography mass spectrometry is the preferable conditions of the first embodiment for the pyrolysis gas chromatography mass spectrometry.

Since tris(isopropylphenyl) phosphate is distributed as a chemical reagent, the standard sample including tris(isopropylphenyl) phosphate adjusted to a specific concentration is analyzed by the hot extraction gas chromatography-mass spectrometry to obtain the mass chromatogram of tris(isopropylphenyl) phosphate. The mass-to-charge ratio (m/z) of the molecular ion of tris(isopropylphenyl) phosphate is 452. The peak area of the molecular ion in the obtained mass chromatogram is then calculated.

When two or more mass chromatograms each including a peak of a molecular ion with a mass-to-charge ratio (m/z) of 452 are obtained by analyzing a standard sample, the sum of the peak areas of the molecular ions of the two or more mass chromatograms each including the peak of the molecular ion with the mass-to-charge ratio (m/z) of 452 (for example, the sum of a peak area of a molecular ion of the mass chromatogram with a duration time of 27.4 [min] in FIG. 5 and a peak area of a molecular ion of the mass chromatogram with a duration time of 28.3 [min] in FIG. 5) is preferably treated as the peak area of the molecular ion of tris(isopropylphenyl) phosphate of the standard sample.

When two or more mass chromatograms related to isopropylphenyl phosphate are obtained, the sum of the peak areas of the molecular ions of isopropylphenyl phosphate of the obtained two or more mass chromatograms (partly or entirely) is treated as the peak area of one or more molecular ions of isopropylphenyl phosphate of the mass chromatogram obtained by analyzing the sample.

Next, the sample is analyzed by gas chromatography mass spectrometry under the same of substantially the same conditions as the conditions for analyzing the standard sample, then a mass chromatogram is obtained. The following selected ion monitoring chromatogram is obtained from the obtained mass chromatogram. The peak area of the molecular ion of one or more (all) mass chromatograms from the selected ion monitoring chromatograms is calculated, and the quantitative analysis of isopropylphenyl phosphate in the sample is performed from the obtained peak areas of the molecular ion.

The selected ion monitoring chromatogram is one or more mass chromatograms selected in determining whether the mass chromatogram includes one or more peaks of one or more product ions and/or one or more molecular ions each having a predetermined mass-to-charge ratio (m/z) (S03) or one or more mass chromatograms whose mass-to-charge ratio (m/z) of the molecular ion is a value selected from the group consisting of 368, 410, 452, 494, 536, and 578.

It is preferable that the selected mass chromatogram is further selected under the following one or more criteria.

### Criterion A

It is preferable that the one or more selected ion monitoring chromatograms to be further selected in the criteria A include all of one or more applicable mass chromatograms. The applicable mass chromatogram is mass chromatogram which includes one or more peaks of one or more molecular ion of isopropylphenyl phosphate.

### Criterion B

It is preferable that the one or more selected ion monitoring chromatograms to be further selected in the criterion B include one or more applicable mass chromatograms of one or more compounds each having a mass-to-charge ratio (m/z) of the molecular ion of 410, 452, 494, 536, or 578 and including a total of one or more and six or less of isopropyl groups introduced into the phenyl groups of isopropylphenyl phosphate.

### Criterion C

It is preferable that the one or more selected ion monitoring chromatograms to be further selected in the criterion C include one or more applicable mass chromatograms of one or more compounds each having a mass-to-charge ratio (m/z) of the molecular ion of 410, 452, 494, 536, or 578 and including a total of one or more and two or less of isopropyl groups introduced into the phenyl groups of isopropylphenyl phosphate.

### Criterion D

It is preferable that the one or more selected ion monitoring chromatograms to be further selected in the criterion D include one or more mass chromatograms of one or more compounds each having a mass-to-charge ratio (m/z) of ion of 410, 452, 494, 536, or 578 and including a total of one or more and six or less of isopropyl groups introduced into the phenyl groups of isopropylphenyl phosphate.

### Criterion E

It is preferable that the one or more selected ion monitoring chromatograms to be further selected in the criterion E include all the mass chromatograms of one or more compounds each having a mass-to-charge ratio (m/z) of ion of 452, 494, 536, or 578 and including a total of two or more and six or less of isopropyl groups introduced into the phenyl groups of isopropylphenyl phosphate.

### Criterion F

It is preferable that the one or more selected ion monitoring chromatograms to be further selected in the criterion F include one or more mass chromatograms of one or more compounds each having a mass-to-charge ratio (m/z) of ion of 452, 494, 536, or 578 and including one or more and two or less of isopropyl groups introduced into each of the three phenyl groups of isopropylphenyl phosphate.

When the quantitative analysis is performed using a mass chromatogram which includes a peak of a molecular ion with a mass-to-charge ratio (m/z) of 368, it is preferable that the mass chromatogram which includes the peak of the molecular ion with the mass-to-charge ratio (m/z) of 368 includes a peak of a product ion with a mass-to-charge ratio (m/z) of 118 or/and a peak of a product ion with a mass-to-charge ratio (m/z) of 251.

When the quantitative analysis is performed using a mass chromatogram which includes a peak of a molecular ion with a mass-to-charge ratio (m/z) of 410, it is preferable that the mass chromatogram which includes the peak of the molecular ion with the mass-to-charge ratio (m/z) of 410 includes one or more peaks of one or more product ions each having a mass-to-charge ratio (m/z) of a value selected from the group consisting of 118, 251, 293, and 335.

When the quantitative analysis is performed using a mass chromatogram which includes a peak of a molecular ion with a mass-to-charge ratio (m/z) of 452, it is preferable that the mass chromatogram which includes the peak of the molecular ion with the mass-to-charge ratio (m/z) of 452 includes one or more peaks of one or more product ions each having a mass-to-charge ratio (m/z) of a value selected from the group consisting of 118, 145, 160, 251, 293, and 335.

When the quantitative analysis is performed using a mass chromatogram which includes a peak of a molecular ion with a mass-to-charge ratio (m/z) of 410, the mass chromatogram which includes the peak of the molecular ion with the mass-to-charge ratio of 410 preferably includes one or more peaks of one or more product ions each having a mass-to-charge ratio (m/z) of a value selected from the group consisting of 118, 251, and 335 and more preferably includes a peak of a product ion having a mass-to-charge ratio (m/z) of 118, a peak of a product ion having a mass-to-charge ratio of 251, and a peak of a product ion having a mass-to-charge ratio of 335.

When the quantitative analysis is performed using a mass chromatogram which includes a peak of a molecular ion with a mass-to-charge ratio (m/z) of 494, it is preferable that the mass chromatogram which includes the peak of the molecular ion with the mass-to-charge ratio (m/z) of 494 includes one or more peaks of one or more product ions each having a mass-to-charge ratio (m/z) of a value selected from the group consisting of 118, 145, 160, 251, 293, and 335.

When the quantitative analysis is performed using a mass chromatogram which includes a peak of a molecular ion with a mass-to-charge ratio (m/z) of 494, the mass chromatogram which includes the peak of the molecular ion with the mass-to-charge ratio of 494 preferably includes one or more peaks of one or more product ions each having a mass-to-charge ratio (m/z) of a value selected from the group consisting of 118, 251, and 335 and more preferably includes a peak of a product ion having a mass-to-charge ratio (m/z) of 118, a peak of a product ion having a mass-to-charge ratio of 251, and a peak of a product ion having a mass-to-charge ratio of 335.

When the quantitative analysis is performed using a mass chromatogram which includes a peak of a molecular ion with a mass-to-charge ratio (m/z) of 536, the mass chromatogram which includes the peak of the molecular ion with the mass-to-charge ratio (m/z) of 536 preferably includes one or more peaks of one or more product ions each having a mass-to-charge ratio (m/z) of a value selected from the group consisting of 118, 145, 160, 251, 293, and 335, and more preferably includes a peak of a product ion having a mass-to-charge ratio (m/z) of 118, a peak of a product ion having a mass-to-charge ratio of 251, and a peak of a product ion having a mass-to-charge ratio of 335.

When the quantitative analysis is performed using a mass chromatogram which includes a peak of a molecular ion with a mass-to-charge ratio (m/z) of 578, the mass chromatogram which includes the peak of the molecular ion with the mass-to-charge ratio (m/z) of 578 preferably includes one or more peaks of one or more product ions each having a mass-to-charge ratio (m/z) of a value selected from the group consisting of 118, 251, and 335, and more preferably includes a peak of a product ion having a mass-to-charge ratio (m/z) of 118, a peak of a product ion having a mass-to-charge ratio of 251, and a peak of a product ion having a mass-to-charge ratio of 335.

The peak area of the molecular ion in the selected ion monitoring chromatogram(s) used for the quantitative analysis is preferably 50% or more and 100% or less of the peak area of the molecular ion of the selected ion monitoring chromatogram(s), more preferably 70% or more and 100% or less of the peak area of the molecular ion of the selected ion monitoring chromatogram(s), and still more preferably 90% or more and 100% or less of the peak area of the molecular ion of the selected ion monitoring chromatogram(s).

The peak area of the molecular ion in the selected ion monitoring chromatogram(s) used for the quantitative analysis is preferably 50% or more and 100% or less of the peak area of the molecular ion of the selected ion monitoring chromatogram(s) selected by one criterion selected from the group consisting of the criterion A, the criterion B, the criterion C, the criterion D, the criterion E, and the criterion F, more preferably 70% or more and 100% or less of the peak area of the molecular ion of the selected ion monitoring chromatogram(s) selected by one criterion selected from the group consisting of the criterion A, the criterion B, the criterion C, the criterion D, the criterion E, and the criterion F, and still more preferably 90% or more and 100% or less of the peak area of the molecular ion of the selected ion monitoring chromatogram(s) selected by one criterion selected from the group consisting of the criterion A, the criterion B, the criterion C, the criterion D, the criterion E, and the criterion F.

Hereinafter, the analysis method of embodiments will be described more specifically based on Examples.

### Example 1

A tris(isopropylphenyl) phosphate solution was used as the standard sample (calibration curve). 10 [μL] of cyclohexane solution containing 100 [μg/mL] of tris(isopropylphenyl) phosphate was sampled, the solvent was volatilized, and the solution was analyzed by Py-GC/MS under the condition 2.

1 [mg] of resin sample 1 (1 [μg] of component of a raw material) containing 0.1% PIP (3:1) as the raw material was sampled and analyzed by Py-GC/MS under the condition 2 as shown below.

### Conditions 2

Temperature of pyrolizer for desorption by hot extraction: 600 [° C.].
Temperature of interface of pyrolizer: automatic.
Column of gas chromatograph: 100% dimethyl polysiloxane, length 15 [m], internal diameter 0.25 [mm], film thickness 0.05 [μm].
Injection temperature of gas chromatograph: 300 [° C.].
Column oven temperature of gas chromatograph: 40 [° C.] (2 minutes retention), increase at 10 [° C./min], up to 320 [° C.].
Injection mode of gas chromatograph: Split 1/50.
Carrier gas of gas chromatograph: He 1 [mL/min], constant flow.
Ionizing method of mass analyzer: EI (Electron Ionization) 70 [eV].
Ion source temperature of mass analyzer: 230 [° C.].
Scan range of mass analyzer: m/z 10 to 600.

The value of the area of the peak of the obtained mass chromatogram at a mass-to-charge ratio m/z of 452, the peak is a peak of the molecular ion of tris(isopropylphenyl) phosphate as a calibration sample, was set to a value of 1.0 [μg].

After confirming the product ions in the mass spectrum obtained during the measurement of the sample to be analyzed, the area values of all peaks of the molecular ions each having a mass-to-charge ratios m/z of 368, 410, 452, 494, or 536 were summed, and the summed values were compared with the area values of the calibration curve sample. As the result, the summed quantitative value was 0.90 [μm].

### Comparative Example 1

10 [μL] of cyclohexane solution containing 100 [μg/mL] of tris(isopropylphenyl) phosphate as the standard sample (calibration curve) was sampled, the solvent was volatilized, and the solution was analyzed by Py-GC/MS under the condition 2.

1 [mg] of resin sample 1 (1 [μg] of component of a raw material) containing 0.1% PIP (3:1) as the raw material was sampled and analyzed by Py-GC/MS under the condition 2.

A total ion chromatogram of TPP of the standard sample, in which TPP is the calibration curve sample, is obtained, and the area value of the total ion chromatogram is set to an area value of 1.0 [μg].

Qualitative ions were confirmed for each chromatogram obtained in the actual sample measurement. Then, each TIC area value was integrated and compared with the area value of the calibration curve sample, and the integrated quantitative value was found to be 1.3 [μg].

The table in FIG. 7 shows the mass-to-charge ratio m/z and the peak area values for each mass chromatographs of isopropylphenyl phosphate in the sample to be analyzed. The “No.” in the table in FIG. 5 corresponds to the “No.” in the table in FIG. 7. Although many product ions are detected as shown in the table in FIG. 7, the examples show that quantitative evaluation by excluding these product ions is more reliable than quantitative evaluation using total ion chromatograms.

Hereinafter, clauses of the embodiments will be described.

### Clause 1

A method of analyzing isopropylphenyl phosphate comprising:
desorbing a sample by hot extraction;
analyzing the desorbed sample to obtain a mass chromatogram of one or more compounds in the sample by gas chromatography mass spectrometry; and
determining whether the mass chromatogram includes one or more peaks of one or more product ions and/or one or more molecular ions each having a predetermined mass-to-charge ratio (m/z).

### Clause 2

The method according to clause 1, wherein
in the determining whether the mass chromatogram includes the one or more peaks of the one or more product ions and/or the one or more molecular ions each having the predetermined mass-to-charge ratio (m/z), whether the mass chromatogram includes one or more peaks of one or more product ions each having a mass-to-charge ratio (m/z) of a value selected from the group consisting of 118, 145, 160, 251, 277, 293, 335, 353, 377, and 452 is evaluated.

### Clause 3

The method according to clause 1, wherein
a desorbing temperature by the hot extraction is 400 [° C.] or more and 700 [° C.] or less, and
in the determining whether the mass chromatogram includes the one or more peaks of the one or more product ions and/or the one or more molecular ions each having the predetermined mass-to-charge ratio (m/z), whether the mass chromatogram includes a peak of a product ion having a mass-to-charge ratio (m/z) of 335 is evaluated.

### Clause 4

The method according to clause 1, wherein
in the determining whether the mass chromatogram includes the one or more peaks of the one or more product ions and/or the one or more molecular ions each having the predetermined mass-to-charge ratio (m/z), whether the mass chromatogram includes one or more peaks of one or more product ions each having a mass-to-charge ratio (m/z) of a value selected from the group consisting of 118, 251, and 335 is evaluated.

### Clause 5

The method according to clause 1, wherein
in the determining whether the mass chromatogram includes the one or more peaks of the one or more product ions and/or the one or more molecular ions each having the predetermined mass-to-charge ratio (m/z), whether the mass chromatogram includes one or more peaks of one or more product ions each having a mass-to-charge ratio (m/z) of a value selected from the group consisting of 118 and 251 and one or more peaks of one or more product ions each having a mass-to-charge ratio (m/z) of a value selected from the group consisting of 145 and 160.

### Clause 6

The method according to clause 1, wherein
in the determining whether the mass chromatogram includes the one or more peaks of the one or more product ions and/or the one or more molecular ions each having the predetermined mass-to-charge ratio (m/z), whether the mass chromatogram includes one or more peaks of one or more product ions each having a mass-to-charge ratio (m/z) of a value selected from the group consisting of 145 and 160 is evaluated.

### Clause 7

The method according to clause 1, wherein
in the determining whether the mass chromatogram includes the one or more peaks of the one or more product ions and/or the one or more molecular ions each having the predetermined mass-to-charge ratio (m/z), whether the mass chromatogram includes peaks of two or more product ions each having a mass-to-charge ratio (m/z) of a value selected from the group consisting of 118, 145, 160, 251, and 335 is evaluated.

### Clause 8

The method according to any one of clauses 1, 2, 4 to 6, wherein
a desorbing temperature by the hot extraction is 400 [° C.] or more and 700 [° C.] or less.

### Clause 9

The method according to any one of clauses 1, 2, 4 to 7, wherein
in the determining whether the mass chromatogram includes the one or more peaks of the one or more product ions and/or the one or more molecular ions each having the predetermined mass-to-charge ratio (m/z), whether the mass chromatogram includes one or more peaks each having a mass-to-charge (m/z) related to one or more molecular ions of isopropylphenyl phosphate is evaluated.

### Clause 10

A method for analyzing isopropylphenyl phosphate comprising:
desorbing a sample by hot extraction;
analyzing the desorbed sample to obtain a mass chromatogram of one or more compounds in the sample by gas chromatography mass spectrometry; and
calculating a concentration of isopropylphenyl phosphate in the sample from one or more areas of one or more peaks of one or more molecular ions of the mass chromatogram.

### Clause 11

The method according to claim 10, wherein
the concentration of isopropylphenyl phosphate is calculated from a ratio “a total peak area of one or more molecular ions of isopropylphenyl phosphate of the mass chromatogram obtained by analyzing the sample” to “a peak area of a molecular ion of tris(isopropylphenyl) phosphate of a mass chromatogram obtained by analyzing a standard sample which includes tris(isopropylphenyl) phosphate by pyrolysis gas chromatography mass spectrometry”.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of analyzing isopropylphenyl phosphate comprising:
desorbing a sample by hot extraction;
analyzing the desorbed sample to obtain a mass chromatogram of one or more compounds in the sample by gas chromatography mass spectrometry; and
determining whether the mass chromatogram includes one or more peaks of one or more product ions and/or one or more molecular ions each having a predetermined mass-to-charge ratio (m/z).

2. The method according to claim 1, wherein
in the determining whether the mass chromatogram includes the one or more peaks of the one or more product ions and/or the one or more molecular ions each having the predetermined mass-to-charge ratio (m/z), whether the mass chromatogram includes one or more peaks of one or more product ions each having a mass-to-charge ratio (m/z) of a value selected from the group consisting of 118, 145, 160, 251, 277, 293, 335, 353, 377, and 452 is evaluated.

3. The method according to claim 1, wherein
a desorbing temperature by the hot extraction is 400 [° C.] or more and 700 [° C.] or less, and
in the determining whether the mass chromatogram includes the one or more peaks of the one or more product ions and/or the one or more molecular ions each having the predetermined mass-to-charge ratio (m/z), whether the mass chromatogram includes a peak of a product ion having a mass-to-charge ratio (m/z) of 335 is evaluated.

4. The method according to claim 1, wherein
in the determining whether the mass chromatogram includes the one or more peaks of the one or more product ions and/or the one or more molecular ions each having the predetermined mass-to-charge ratio (m/z), whether the mass chromatogram includes one or more peaks of one or more product ions each having a mass-to-charge ratio (m/z) of a value selected from the group consisting of 118, 251, and 335 is evaluated.

5. The method according to claim 1, wherein
in the determining whether the mass chromatogram includes the one or more peaks of the one or more product ions and/or the one or more molecular ions each having the predetermined mass-to-charge ratio (m/z), whether the mass chromatogram includes one or more peaks of one or more product ions each having a mass-to-charge ratio (m/z) of a value selected from the group consisting of 118 and 251 and one or more peaks of one or more product ions each having a mass-to-charge ratio (m/z) of a value selected from the group consisting of 145 and 160.

6. The method according to claim 1, wherein
in the determining whether the mass chromatogram includes the one or more peaks of the one or more product ions and/or the one or more molecular ions each having the predetermined mass-to-charge ratio (m/z), whether the mass chromatogram includes one or more peaks of one or more product ions each having a mass-to-charge ratio (m/z) of a value selected from the group consisting of 145 and 160 is evaluated.

7. The method according to claim 1, wherein
in the determining whether the mass chromatogram includes the one or more peaks of the one or more product ions and/or the one or more molecular ions each having the predetermined mass-to-charge ratio (m/z), whether the mass chromatogram includes peaks of two or more product ions each having a mass-to-charge ratio (m/z) of a value selected from the group consisting of 118, 145, 160, 251, and 335 is evaluated.

8. The method according to claim 1, wherein
a desorbing temperature by the hot extraction is 400 [° C.] or more and 700 [° C.] or less.

9. The method according to claim 1, wherein
in the determining whether the mass chromatogram includes the one or more peaks of the one or more product ions and/or the one or more molecular ions each having the predetermined mass-to-charge ratio (m/z), whether the mass chromatogram includes one or more peaks each having a mass-to-charge (m/z) related to one or more molecular ions of isopropylphenyl phosphate is evaluated.

10. A method for analyzing isopropylphenyl phosphate comprising:
desorbing a sample by hot extraction;
analyzing the desorbed sample to obtain a mass chromatogram of one or more compounds in the sample by gas chromatography mass spectrometry; and
calculating a concentration of isopropylphenyl phosphate in the sample from one or more areas of one or more peaks of one or more molecular ions of the mass chromatogram.

11. The method according to claim 10, wherein
the concentration of isopropylphenyl phosphate is calculated from a ratio “a total peak area of one or more molecular ions of isopropylphenyl phosphate of the mass chromatogram obtained by analyzing the sample” to “a peak area of a molecular ion of tris(isopropylphenyl) phosphate of a mass chromatogram obtained by analyzing a standard sample which includes tris(isopropylphenyl) phosphate by pyrolysis gas chromatography mass spectrometry”.
